(19) United States
(12) Patent Application Publication
(10) Pub. No.: US 2025/0159016 A1
(43) Pub. Date: May 15, 2025

(54) ATTACK PATH DISCOVERY ENGINE IN A SECURITY MANAGEMENT SYSTEM

(71) Applicant: Microsoft Technology Licensing, LLC, Redmond, WA (US)

(72) Inventors: Idan HEN, Tel Aviv (IL); Amit MAGEN MEDINA, Netanya (IL); Chen LAHAV, Givatayim (IL); Alon DANOCH, Givatayim (IL); Asaf HARARI, Tel Aviv (IL); Aviv SHITRIT, Atlit (IL); Lior ZIV, Tel Aviv (IL)

(21) Appl. No.: 18/508,086

(22) Filed: Nov. 13, 2023

(51) Int. Cl. H04L 9/40

(52) U.S. Cl. CPC H04L 63/145; H04L 63/1416

(57) ABSTRACT

Methods, systems, and computer storage media for providing attack path discovery management using an attack path discovery engine of a security management system. Attack path discovery management supports automatic attack path discovery that involves identifying and mapping potential pathways that attackers could use to infiltrate computing environments. In operation, an attack path discovery computation model comprising an entry point element, an advancement step element, and a target element, is accessed. A computing environment graph comprising computing components of a computing environment is accessed. Based on the entry point element, an entry point is identified in the computing graph; based on the advancement step element, an advancement step is identified in the computing environment graph; and based on the target element, a target is identified in the computing environment graph. An attack path is generated based on the entry point, the advancement steps, and the target. The attack path is communicated.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, data security posture management (DSPM), cloud security posture management (CSPM) and enterprise security posture management (collectively “security posture management”) can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing attack path discovery management using an attack path discovery engine of a security management system. Attack path discovery management supports automatic attack path discovery that involves identifying and mapping potential pathways that attackers could use to infiltrate a computer environment, network, or application. Attack path discovery can be part of security management of a computing environment based on identifying attack paths associated with the computing environment. In particular, the security management system provides an attack path discovery engine that operates based on an attack path discovery framework having an attack path computation model.

The attack path computation model provides an attack path discovery logic or algorithm that includes elements (e.g., entry point element, advancement step element, and target element) of an attack path discovery template. The elements are associated with corresponding conditions that may or may not be met by components in a computing environment. Traversing a computing environment graph using the attack path computation model and attack path logic supports automatically identifying attack paths. The attack path discovery logic is based on computing components and attack operations that a potential attacker may employ to gain unauthorized access to different computing devices in a computing environment. The attack operations are defined in the attack path discovery template based on the specific elements associated with different types of attack paths. In this way, an attack path discovery computation model can access a plurality entry points, advancements steps, and targets (“elements”) in the attack path discovery template, and the elements are used to traverse a computing environment of (e.g., computing environment graph) to identify attack paths in the computing environment.

Conventionally, security management systems are not configured with a comprehensive computing logic and infrastructure to automatically discover attack paths for a computing environment. For example, a security management system with manually-generated attack paths includes attack path discovery provided by individual security analysts and their knowledge about attacker movements and the topology of a computing environment. To generate an attack path, the security analyst can generate handcrafted logic dedicated to each path instance. Manually generating attacks path in this manner can be time consuming, prone to mistakes, hard to maintain, and biased towards expert knowledge. Manual development of attack paths may not be scalable especially for large systems that have hundreds of thousands of computing components and resources. As such, conventional security management systems lack integration with attack path discovery engine operations associated with automatic attack path discovery that improves the identification of sequences of steps that an attacker takes to gain unauthorized access a target asset—and attack path discovery management.

A technical solution—to the limitations of conventional security management systems—can include the challenge of generating the attack path computation model and employing the attack path computation model to identify attack paths—and providing security management operations and interfaces via an attack path discovery engine in a security management system. An attack path discovery framework (e.g., attack path discovery engine that includes attack path discovery computation model and an attack path discovery template) can be implemented to support efficient functionality for automatically discovering attack paths-using computing environment graphs (e.g., security graph) of computing environments. As such, the security management system can be improved based on attack path discovery engine operations that operate to automatically identify attack paths and provide security posture information of a computing environment in a particular manner.

In operation, an attack path discovery computation model comprising an entry point element, an advancement step element, and a target element associated with an attack path discovery template, is accessed. A computing environment graph comprising computing components of a computing environment is accessed. Based on the entry point element, an entry point is identified in the computing graph; based on the advancement step element, an advancement step is identified in the computing environment graph; and based on the target element, a target is identified in the computing environment graph. An attack path is generated based on the entry point, the advancement steps, and the target. The attack path is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system that includes an attack path discovery engine, in accordance with aspects of the technology described herein;

FIG. 2A is a block diagram of an exemplary security management system that includes an attack path discovery engine, in accordance with aspects of the technology described herein;

FIG. 2B is a block diagram of an exemplary security management system that includes an attack path discovery engine, in accordance with aspects of the technology described herein;

FIG. 3 provides a first exemplary method of providing attack path discovery management using an attack path discovery engine, in accordance with aspects of the technology described herein;

FIG. 4 provides a second exemplary method of providing attack path discovery management using an attack path discovery engine, in accordance with aspects of the technology described herein;

FIG. 5 provides a third exemplary method of providing attack path discovery management using an attack path discovery engine, in accordance with aspects of the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

A security management system supports management of security aspects of data, resources, and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response. The security management system can further support providing attack path discovery management with security management operations (e.g., security investigation queries) that support identifying potential threats and actual threats.

Security management system can use attack paths as a tool for understanding, assessing, and mitigating security risks. Attack paths can refer to the sequences of steps or vulnerabilities that an attacker can exploit to gain unauthorized access to a target system, network, or data. Attack paths are used to model and analyze potential threats and security weaknesses, helping organizations identify and mitigate risks. Attack paths are used to assess the security risks and vulnerabilities within an organization's infrastructure. By mapping out potential attack paths, security professionals can identify weak points and prioritize security measures. Security teams analyze the vulnerabilities and weaknesses that could be exploited in the attack paths. This involves evaluating the susceptibility of systems and applications to various types of attacks, such as software vulnerabilities, misconfigurations, or social engineering. Security incident response plans often include predefined attack paths and scenarios. This helps organizations respond effectively when security incidents occur by following established procedures and containment steps. By understanding attack paths, organizations can implement security controls, patches, and countermeasures to mitigate vulnerabilities and minimize the risk of exploitation. This might involve applying security patches, enforcing access controls, and educating users on security best practices.

Conventionally, security management systems are not configured with a comprehensive computing logic and infrastructure to automatically discover attack paths for a computing environment. For example, a security management system with manually-generated attack paths includes attack path discovery provided by individual security analysts and their knowledge about attacker movements and the topology of a computing environment. Such security management systems lack integration with attack path discovery engine operations associated with automatic attack path discovery that improves the identification of sequences of steps that an attacker takes to gain unauthorized access a target asset—and attack path discovery management.

A security management system may not adequately take advantage of existing knowledge of attack paths. For example, a set of attack paths for a computing environment may be associated with different paths in a security graph of a computing environment. A first attack path can be associated with a virtual machine (VM) that is exposed to the internet, a managed identity, and a database store. A second attack path can be associated with a VM, connected to a managed identity, and then to a second VM, a second managed identity, and then to a database store. Each of these attack paths is maintained with corresponding attack path query. Nonetheless, the underlying template attack path (i.e., structure of the attack path) is essentially the same.

Moreover, manual attack path discovery does not leverage an understanding of attack paths which can illustrate that the set of attack paths are essentially permutations of defined attack steps. In addition, maintaining attack path queries associated with each attack path in the set of attack paths can be tedious. In particular, if a change is made to the structure of a computing environment graph (e.g., security graph) the attack path queries have to be updated to reflect the change. Managing attack paths in this manner does not scale in cloud computing environment with vast amounts of computing devices and potential attack paths. As such, a more comprehensive security management system—with an alternative basis for performing security management operations—can improve computing operations and interfaces for security management.

Embodiments of the present technical solution are directed to systems, methods, and computer storage media, for among other things, providing attack path discovery management using an attack path discovery engine of a security management system. Attack path discovery management supports automatic attack path discovery that involves identifying and mapping potential pathways that attackers could use to infiltrate a computer environment, network, or application. Attack path discovery can be part of security management of a computing environment based on identifying attack paths associated with the computing environment. In particular, the security management system provides an attack path discovery engine that operates based on an attack path discovery framework having an attack path computation model. The attack path computation model provides an attack path discovery logic or algorithm that includes elements (e.g., entry point element, advancement step element, and target element) of an attack path discovery template. The elements are associated with corresponding conditions that may or may not be met by components in a computing environment. Traversing a computing environment graph using the attack path computation model and attack path logic supports automatically identifying attack paths. The attack path discovery logic is based on computing components and attack operations that a potential attacker may employ to gain unauthorized access to different computing devices in a computing environment. The attack operations are defined in the attack path discovery template based on the specific elements associated with different types of attack paths.

In this way, an attack path discovery computation model be programmed with a plurality entry points, advancements steps, and targets that are used to traverse a computing environment of a computing environment graph to identify attack paths associated with computing environment. Based on the attack path discovery computation model and the automatically discovered attack paths, attack path discovery management can be provided to support management of security aspects of data, resources, and workloads in computing environments including identifying and remediating risk. Attack path discovery management is provided using the attack path discovery engine that is operationally integrated into the security management system. The security management system supports an attack path discovery engine framework of computing components associated with artificial intelligence security graph comprising contextual information of artificial-intelligence-supported applications for determining a security posture of a computing environment.

At a high level, automatic attack path discovery is provided via a security management system. An attack path discovery engine in the security management engine automatically generates attack paths given minimal effort and maintenance. In particular, an attack path discovery engine breaks down a possible attacker's movements into a small set of valid steps and receives the following input: relations between system entities (e.g., organization cloud environment graph); configuration of valid source nodes, target nodes and conditions and steps an attacker can take in an attack path discovery template. For example: Valid Sources: {Virtual Machine, . . . , sourceₙ}; Valid Targets: Virtual Machine, . . . , targetₘ}; Valid Steps: {{Virtual Machine, can authenticate as, Virtual Machine}, . . . , {stepₖ}}. In one embodiment, given the attack path discovery template, the attack path discovery engine first reads the relations between system's entities and builds a security graph, then formulates the possible attacker steps (i.e. sources, step, and targets) as a set of graph-based constraints. Finally, the attack path discovery engine processes the graph subject to the constraints and outputs valid attack paths. And, when there are updates to the computing environment, relations between entities or our knowledge about attacker movements, the attack path discovery engine will automatically generate updated attack paths.

By way of context, a security management system may have several attack paths that are used to evaluate the security posture of a computing environment. The attack paths can be used to generate attack path queries, where an attack path query can be executed against a security graph of a computing environment. In particular, an attack path query can include attack path query attributes that are executed against a security graph associated with a computing environment to determine whether an attack path exists in the computing environment. The attack path query hardcodes the specific attack path that needs to be identified. Attack path queries can be manually written to align with specific configurations and computing components (e.g., computing components of different cloud computing system providers). Attack path queries can be executed on security graphs associated with a computing environment to identify instances within the security where the attack path exists. As such, evaluating the security posture for a computing environment is limited to known attack paths from manually-generated queries. Because attack paths are manually generated, this limits the ability to efficiently and expediently identify attack paths and employ attack path queries to assess the security posture of a computing environment.

As such, a security management system can be implemented to support an attack path discovery framework including an attack path discovery algorithm. In particular, the security management system moves away from managing specific queries to managing attack path discovery. For example, the attack path discovery algorithm, can define key attack path attributes and attack path logic that can be associated with a plurality of different attack paths that share the same underlying key attack path attributes and attack path logic. An attack path discovery template can include key path attributes (e.g., entry points, advancement steps, and targets) and conditions that determine how to automatically identify attack paths using a computing environment graph (e.g., MICROSOFT graph “computer environment graph”) associated with a computing environment. A computing environment graph can refer to graphical representation of the relationships and interactions between various elements within a computing environment. These elements can include devices, networks, users, applications, and other components that make up an organization's IT infrastructure. The graph helps visualize the connections and dependencies between these elements, providing a comprehensive view of the entire computing ecosystem.

The attack path discovery framework can provide rules for how to explore a security graph the same way an attacker would. For example, an attack path discovery template could indicate that if an attacker gets access to a node that is a managed identity, and one of the edges to the nodes has permissions on a VM-then that would be an indication of an attack path. Executing this attack path discovery template on a security graph can identify all instances of the attack paths that match the attack path discovery template on the security graph.

An attack path discovery engine operates based on an attack path discovery framework that supports evaluating attack operations and conditions on a security graph. The attack operations are a set of actions that a potential attacker may execute to gain unauthorized access to different computing devices in a computing environment. The attack operations may evaluate how an attacker would exploit specific vulnerabilities in computing environments and the results of the evaluation can be used to automatically identify attack paths in a computing environment. The attack path operations can be executed on a computing environment graph associated computing components of a computing environment. For example, an attack path operation can be used to evaluate how an attacker would perform lateral movements in a computing environment.

An attack path discovery engine template can be generated to include three different attack path definition elements (e.g., entry point element, advancement step element, target element). An entry point (i.e., entry point element) can be a starting point for a path. For example, an entry point can specifically refer to a VM that is exposed to the internet, which provides a means for an attacker to gain access to the computing environment. The conditions associated with the entry point, as identified in an attack path discover template, are evaluated to select a VM as an entry point. Example entry point elements can include internet exposed VM with high severity vulnerabilities; VM with high severity vulnerabilities; and internet exposed and publicly accessible storage.

Advancement step (i.e., advancement step element) can refer to operations and conditions that are met via an entry point to gain access to another computing component. Several advancement steps and corresponding parameters (e.g., operation and conditions) can be defined for an entry point. The advancement steps can include conditions that have to be met into order to support identifying a potential attack path. For example, after a VM is identified as an entry point with access to the internet, an advancement step supports evaluating whether the VM has a vulnerability that could be exploited. Advancement step elements in an attack path discovery template can indicate that a potential attack path exists: if the VM has a vulnerability; an edge indicates that the VM has rights to authenticate to a destination node (e.g., managed identity); and the destination node is a managed identity. In this way, advancement steps can be defined as a triplet of source node, edge, and destination node. Each element of the triplet can be associated with a set of conditions. For example, source node has critical vulnerability that an attacker can exploit, the edge has to be a “can authenticate” edge with a specific permission, and destination node has to be a managed identity. Target (i.e., target element) can refer to endpoints of an attack path. A target can be a critical computing component “critical assets” in the computing environment. For example, a target may be a database with sensitive data or financial information. Targets can be specific devices in the computing environment that is identified as critical.

Using attack discovery template with entry point elements, advancement step elements, and target elements associated with the attack path discovery computation model and the attack path discovery engine support automatic discovery of attack paths. The attack path discovery engine mimics or simulates the actions of a potential attacker. Simulating the actions of a potential attack is based on a set of rules that are defined in attack path discovery template. Using the attack path discovery template, the attack path discovery engine traverses a graph topology of computing components in a computing environment to discover attack paths in the computing environment.

Advantageously, the embodiments of the present technical solution include several inventive features (e.g., operations, systems, engines, and components) associated with a security management system having an attack path discovery engine. The attack path discovery engine supports attack path discovery engine operations used to employ an attack path discovery template and an attack path discovery computation model to automatically identify attack path—and provide security management operations and interfaces via an attack path discovery engine in a security management system. The attack path discovery engine operations are a solution to a specific problem (e.g., limitations in effective identification and management of attack paths in computing environment) in security management. The attack path discovery engine provides ordered combination of operations for using an attack path computation model to traverse a computing environment graph to automatically identify attack paths in a way that improves computing operations in a security management system. Moreover, security posture information for applications is provided in a particular manner that improves user interfaces of the security management system.

### Example Systems and Operations

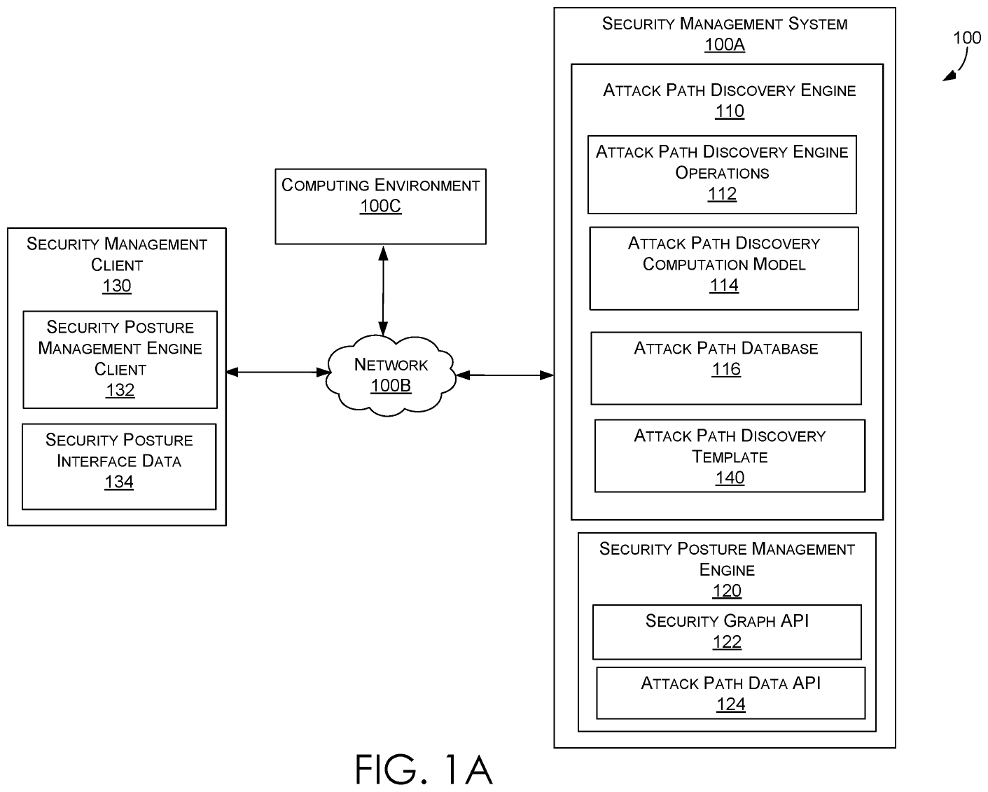

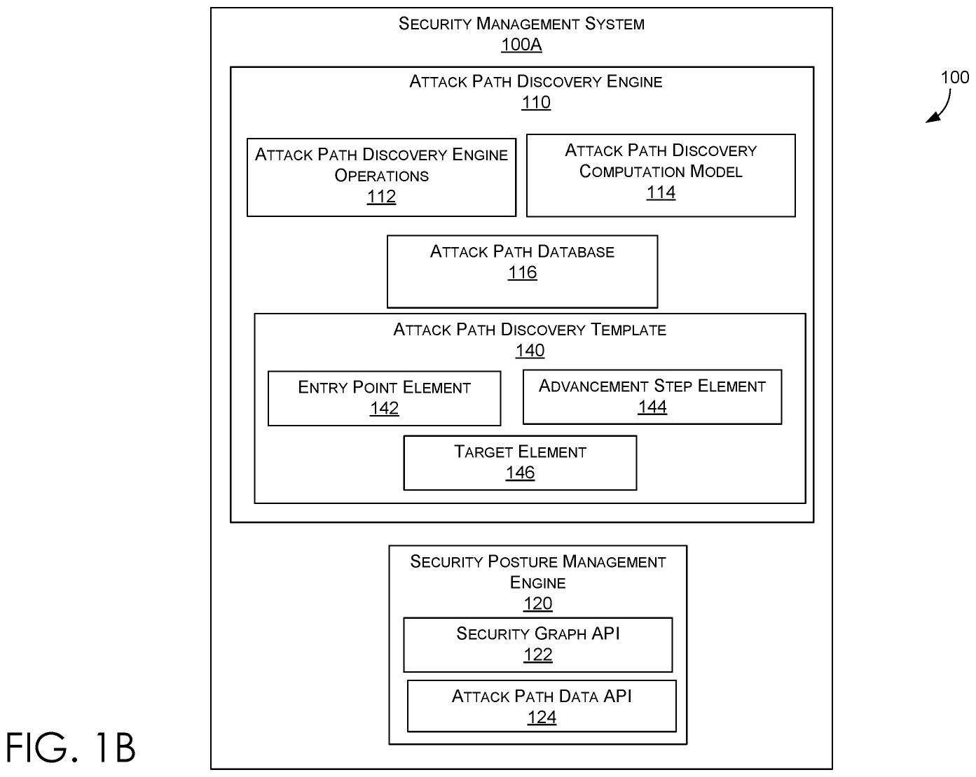

Aspects of the technical solution can be described by way of examples and with reference to FIGS. 1A-1B. FIG. 1A illustrates a cloud computing system (environment) 100 including security management system 100A; network 100B; computing environment 100C; attack path discovery engine 110 having attack path discovery engine operations 112, attack path discovery computation model 114, attack path database 116; security posture management engine 120 with security graph API 122 and attack path data API 124; and security management client 130 with security posture management engine client 132 and security posture interface data 134; and attack path discovery template 140.

The cloud computing environment 100 provides computing system resources for different types of managed computing environments. For example, the cloud computing environment 100 supports delivery of computing services-including servers, storage, databases, networking, and security intelligence. A plurality of security management clients (e.g., security management client 130) include hardware or software that access resources in the cloud computing environment 100. Computing environment 100C can be a managed computing environment where attack path discovery can be performed. Computing environment 100C can be a cloud computing environment, a public cloud, private cloud, hybrid cloud, or edge computing environment associated different cloud providers. Other variations and combinations of cloud computing models and hybrid solutions are contemplated with the computing environment 100C.

Security management client 130 can include an application or service that supports client-side functionality associated with cloud computing environment 100. The plurality of security management clients can access computing components of the cloud computing environment 100 via a network (e.g., network 100B) to perform computing operations. The security management client 130 can be associated with a wide range of security services that support client-side functionality associated with the security management system in the cloud computing environment. The security management client 140 can provide an interface of a security service that operates with the attack path discovery engine in the cloud computing environment. Operations from the security management client may include providing security posture information that is associated with automatically discovered attack paths via the attack path discovery engine 110.

The security management system 100A is designed to provide security management using the attack path discovery engine 110. The security management system 100A provides an integrated operating environment based on a security management framework of computing components associated with providing the attack path discovery engine 110, attack path discovery operations 112, attack path discovery computation model 113, and attack path discovery template 140. The security management system 100A integrates attack path discovery engine operations 112—that support identifying attack paths in a computing environment and employing the security posture management engine 120 to effectively provide security posture investigation information, security posture information, and remediation information for a computing environment. For example, a security administrator can request security posture information of a computing environment, and the security posture information is provided based in part based on the artificial intelligence security graph 116.

The attack path discovery engine 110 is responsible for identifying and communicating attack paths for a computing environment. The attack path discovery engine 110 can provide attack path discovery engine operations 112 to support automatically identifying attack paths. The attack path discovery engine 120 accesses the attack path discovery computation model 114 that supports automatically discovering attack paths for computing environments associated with computing environment graphs. Attack path discovery can be based on attack path discovery templates (e.g., attack path discovery template 140) that include elements (e.g., entry point elements, advancement step element, and target) that are used to traverse computing environment graphs (e.g., via security graph API) to identify attack paths. Attack paths can be identified and stored in an attack path database 116. The attack paths can further be communicated via attack path data API 124 to one or more security services associated with a security management system 100A.

The attack path discovery engine 110 accesses computing environment data (e.g., computing environment graph data) associated with a plurality of data sources. The data sources can include cloud storage, databases, cloud applications, streaming data, service application and external data sources associated with attack path discovery management. Computing environment data further includes data retrieved via the security graph API 122 (e.g., MICROSOFT graph). Computing environment data can be associated with plurality of computing resources (e.g., virtual machines, storage, databases, tenant, content delivery network, containers, monitoring and analytics, development). Computing environment data can include security log data that includes detailed audit trail and evidence of security-related events for monitoring, analysis and investigation purposes.

The security posture management engine 120 is responsible for communicating with a security management client 130 having the security posture management engine client 132 and the security incident interface data 134. The security posture management engine client 132 supports client-side security management operations for providing security management in the security management system 100. The security posture management engine client 132 supports presenting a security posture visualization-including attack paths-associated with the attack path discovery path 114, and communicating an indication to perform a remediation action associated with attack path discovery paths. As such, the security incident interface data 134 can include data associated with the attack path discovery engine 110, and data associated with the security posture management 120 which can be communicated between the attack path discovery engine 110, the security posture management engine 120, and the security management client 130.

The security posture management engine 120 operates to provide visibility to security status of resources in a computing environment. Security posture information can be associated with attack path discovery engine 110, network, data, and identity resources of a computing environment. Security posture information can include attack paths with prioritization identifiers. The security posture management engine 120 includes a security graph API 122 that provides access to a security graph (not shown) and security graph data. The security graph provides telemetry data associated with a plurality of resources in a computing environment. In particular, the telemetry data can be security data that is associated with security providers in a computing environment. The security graph and security graph API 122 can support integrating security alerts from different security providers via an API connector that streams alerts to the security posture management engine 120. For example, the attack path discovery engine 110 can operate as a security provider for the security posture management engine 120.

The security posture management engine 120 may assess threats and develop risk scores-using risk assessment operations including attack path analysis-associated with threats and attack paths. An attack path analysis can refer to a graph-based algorithm that scans a cloud security graph to identify exploitable paths including attack surfaces that attackers may use to breach a computing environment. The attack path analysis exposes attack paths and suggests remediation actions for issues that would break the attack path and prevent a successful breach. In this way, the attack path analysis help address security issues that pose immediate threat with the greatest potential of being exploited in a computing environment. Other variations and combinations of risk assessment operations are contemplated with embodiments of the present disclosure.

The security posture management engine 120 can further support generating security posture visualizations based on the security posture information including attack paths. Security posture information can include query results, which can be provided in combination with attack path analysis, alerts, and other security management information. For example, a security posture visualization can include query results associated with attack paths and the attack path discovery engine 110. The security posture information can be generated based on attack paths such that security posture information is prioritized and filtered. A prioritization identifier (e.g., high, medium, low) can be provided for attack paths in the security posture visualization. The prioritization identifier can specifically include a prioritization identifier that is provided or updated based on analyzing an attack path monitored data. Alternatively, a notification associated with the security management information, security prioritization information or the alert can be communicated. Other variations and combinations of communications associated with the unsecured credential are contemplated with embodiments described herein.

The security management client 130 can support accessing a security posture visualization and causing display of the security posture visualization. The security management client 130 can include the security posture management engine client 132 that supports receiving the security posture interface data 134 from the security management system 100A and causing presentation of the security posture interface data 134. The security posture interface data 134 can specifically include security posture visualizations associated with attack path discovery engine 110. The secure posture visualization can further include remediation actions associated with different attack paths—including security alerts that are associated with the query results.

The security management client 130 can further support executing a remediation action. In particular, the security posture visualization can include a remediation action for an attack path or attack path security alert with a prioritization identifier. The security management client 130 can receive an indication to perform the remediation action associated with query results. Based on receiving the indication to execute the remediation action, the security management client 130 can communicate the indication to execute the remediation action to cause execution of the remediation action.

As such, attack paths and related security posture information are generated based on the attack path discovery engine 110 and provided with remediation actions that can be selected and communicated to cause the remediation action to be performed. The remediation action can address an actual threat or potential threat associated with the attack paths. For example, a remediation action can include off-boarding a computing device, disabling a user, quarantining a file; turning off external email, or running an antivirus scan. Other variations and combinations of security posture visualizations with the artificial intelligence security graph 114 are contemplated with embodiments described herein.

With reference to FIG. 1B, FIG. 1B illustrates attack path discovery engine 110—having attack path discovery engine operations 112, attack path discovery computation model, attack path database 116, and attack path discovery template 140 including entry point element 142, advancement step element 144, target element 146; security posture management engine 120 including security graph API 122 and attack path data API 124.

The attack path discovery engine 110 provides an attack path discovery computation model 114 as a computational model that supports automatically identifying attack paths. The attack path discovery computation model 114 can be associated with operations that are executed to automatically identify and store attack paths in attack path database 116. The computational model is configured to employ attack path discovery templates that include entry point element 142, advancement step element 144, and target element 146. The computational model supports programmatically accessing a computing environment graph to identify attack paths. The computational model can also support accessing a computing environment graph and generating a security graph (e.g., attack path discovery security graph) based on the relationships between entities in the computing environment, and then employing the attack path discovery security graph for identifying attack paths. It is contemplated that the attack path discovery engine 110 can access computing environment graph and first generate a security graph, and then employ the attack path discovery template to automatically identify attack paths in the computing environment.

The attack path discovery engine 110 can access the attack path discovery template 140 to identify a plurality of attack paths based on the entry point element 142, advancement step element 144, and the target element 146. The entry point element 142, advancement step element 144, and the target element 146 can each be associated with conditions that when met support identifying a potential attack path. Identifying an attack path can include the following: based on the entry point element, identify an entry point in the computing environment graph; based on the advancement step element, identify an advancement step in the computing environment graph; based on the target element, identify a target in the computing environment graph; and then generating the attack based on the entry point, the advancement step, and the target.

The attack path discovery engine 110 can further be configured to listen for updates to a computing environment or updates to the attack path discovery template 140. Based on an update to a computing environment (e.g., via a computing environment graph) or update to the attack path discovery template 140, the attack path discovery engine 110 can automatically identify new attack paths for the updated computing environment or associated with the updated attack path discovery template.

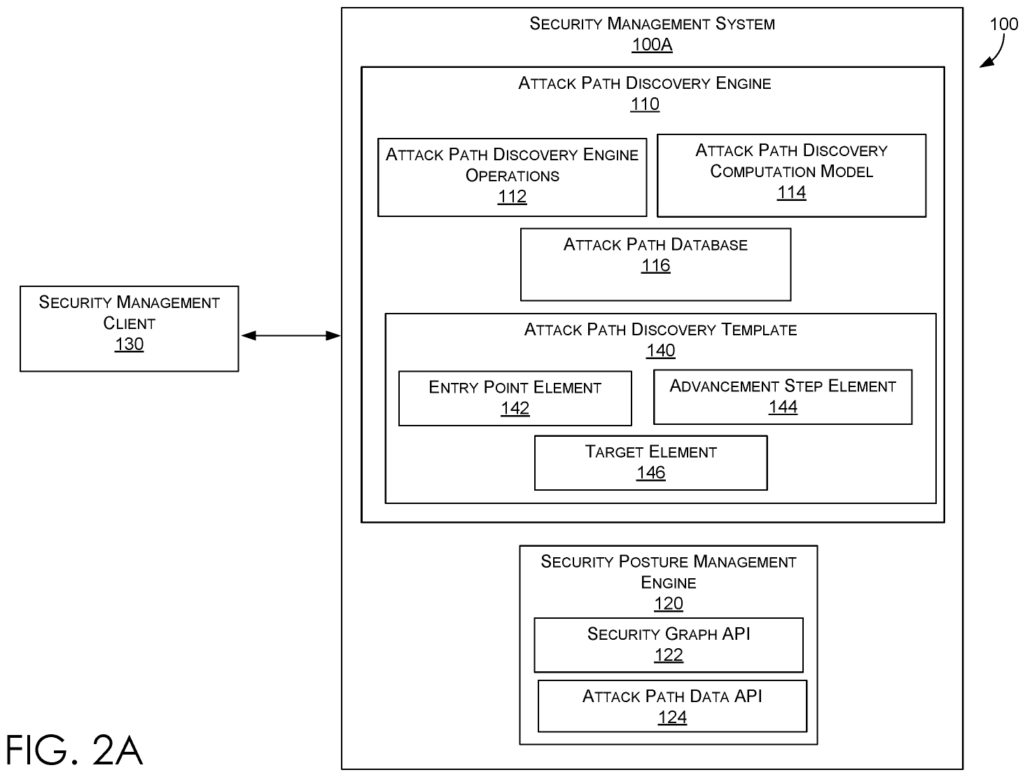

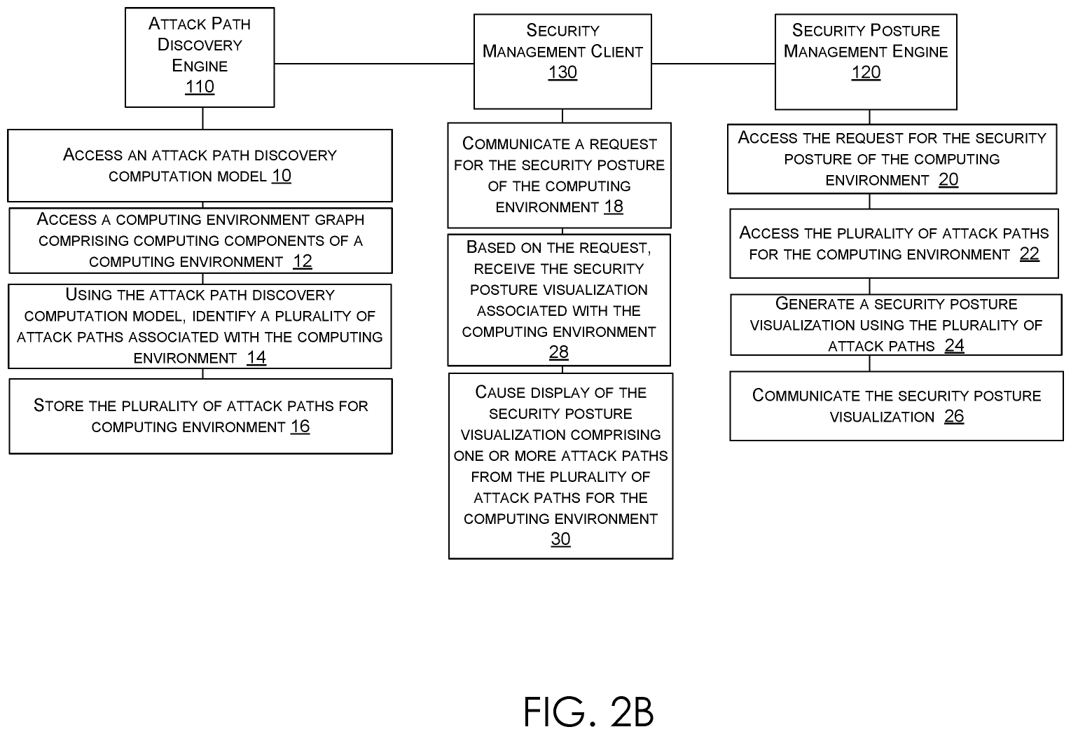

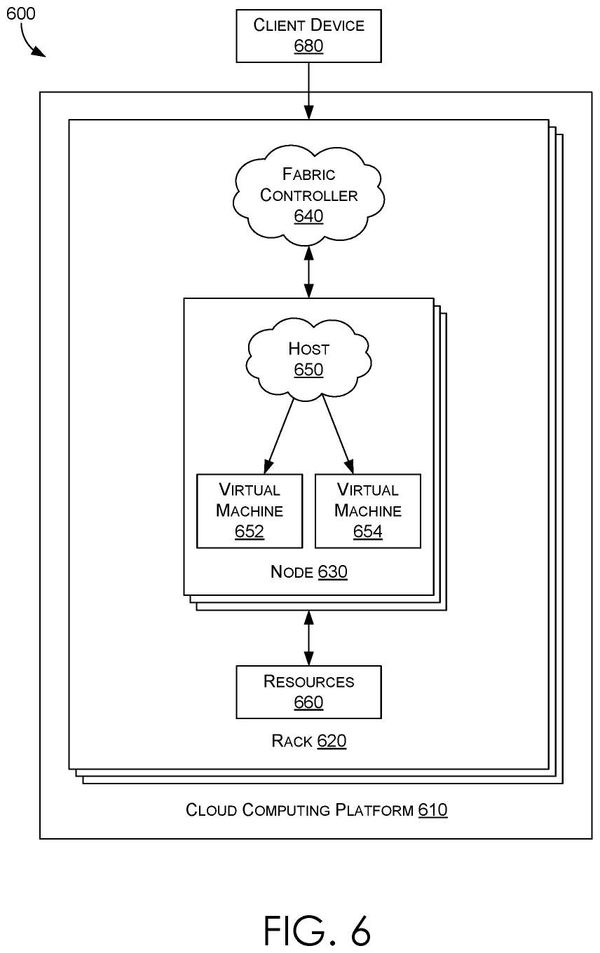

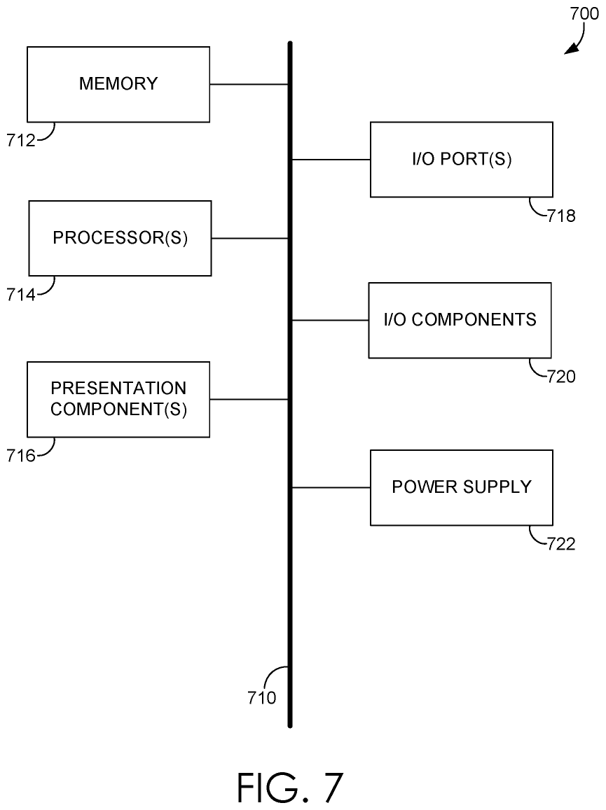

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example security management system 100 in which methods of the present disclosure may be employed. In particular, FIG. 2A shows a high level architecture of the security management system 100A in accordance with implementations of the present disclosure. Among other engines, managers, generators, selectors, or components not shown (collectively referred to herein as “components”), the technical solution environment of security management system 100 corresponds to FIGS. 1A and 1B.

With reference to FIG. 2A, FIG. 2A illustrates a security management system 100A having security management system 100A, attack path discovery engine 110 including attack path discovery engine operations 112, attack path discovery computation model 114, attack path database 116, and attack path discovery template 140 having entry point element 142, advancement step element 144, and target element 146; security posture management engine having security graph API 122 and attack path data API 124; and security management client 130.

The attack path discovery engine 110 accesses an attack path discovery computation model 114. The attack path discovery computation model 114 supports automatically discovering attack paths for computing environments associated with computing environment graphs. Using the attack path discovery computation model 114 and a computing environment graph of a computing environment, the attack path discovery engine 110 identifies a plurality of attack paths associated with the computing environment and communicates the plurality of attack paths for the computing environment. The attack path discovery engine 110 can store the plurality of attack paths in attack path database 116. The attack path database 116 is associated with one or more security services via an attack path data API 124. The one or more security services access the plurality of attack paths to support executing security operations.

The attack path discovery computation model 114 further accesses an attack path discovery template 140 comprising an entry point element 142, an advancement step element 144, and a target element 146 associated with corresponding conditions that are evaluated to identify the plurality of attack paths. The entry point element is associated with two or more of the following: an entry point tile, an entry point node, an entry point insight, and an entry point condition. The advancement step element is associated with three or more of the following a source node, an edge, a target node, a target node condition, an edge condition, and an action. The target element is associated with two or more of the following: a target title, a target, a target insight, and a target condition.

The attack path discovery engine 110 can operate to access an updated version of the computing environment graph and using the attack path computation model and the updated version of the computing environment graph, identify a second plurality of attack paths for the computing environment. The attack path discovery engine 110 can further communicate the second plurality of attack paths for the computing environment.

The security posture management engine 120 can communicate a security posture visualization comprising an attack path, where the attack path is associated with a prioritization identifier and a risk score. The security posture management engine can receive a request for the security posture of the computing environment; generate a security posture visualization associated with the computing environment, where the security posture visualization comprises one or more attack paths; and communicate the security posture visualization comprising the one or more attack paths.

The security management client 130 can communicate a request for security posture associated with a computing environment; and based on the request, receive a security posture visualization associated with the computing environment, where the security posture visualization is associated with one or more attack path; and cause display of the security visualization comprising the one or more attack for the computing environment. The security management client can further receive an indication to execute a remediation action associated with an attack path associated with the security visualization; and execute the remediation action.

With reference to FIG. 2B, FIG. 2B illustrates a security management system 100A having attack path discovery engine 110, security management client 130, and security posture management engine 120. At block 10, the attack path discovery engine 110 accesses an attack path discovery computation model; at block 12, accesses a computing environment graph comprising computing components of a computing environment; and at block 14, using the attack path discovery computation model, identifies a plurality of attack paths associated with the computing environment; and at block 16, stores the plurality of attack paths for the computing environment.

At block, 18 the security management client 130 communicates a request for the security posture of the computing environment. At block 20, the security posture management engine, accesses the request for the security posture of the computing environment; at block 22, accesses the plurality of attack paths for the computing environment; at block 24, generates a security posture visualization using the plurality of attack paths; at block 26, communicates the security posture visualization. At block 28, the security management client 130, based on the request, receives the security posture visualization associated with the computing environment; and at block 30, causes display of the security posture visualization comprising one or more attack paths from the plurality of attack paths for the computing environment.

### Example Methods

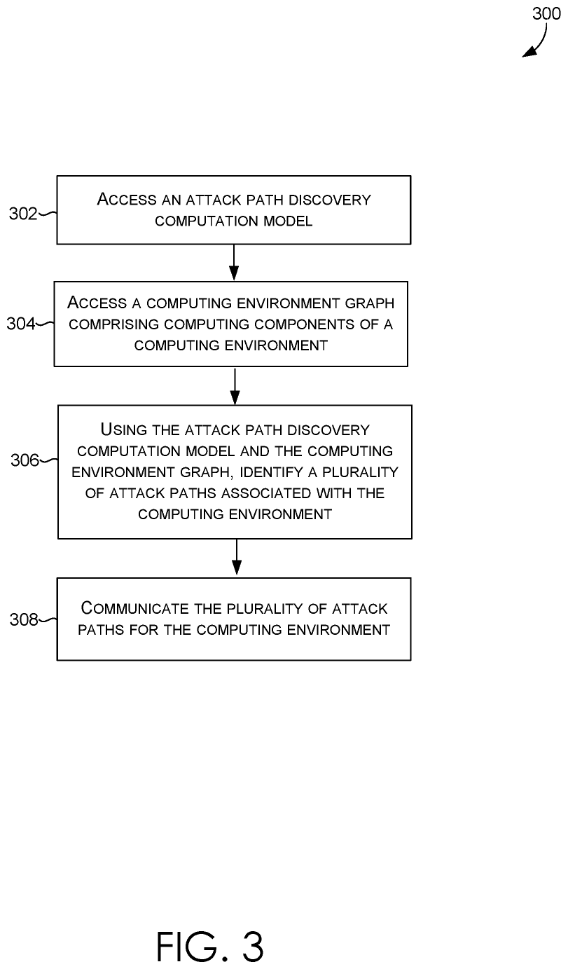

With reference to FIGS. 3, 4, and 5, flow diagrams are provided illustrating methods for providing attack path discovery management using an attack path discovery engine in a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system or computing system).

Turning to FIG. 3, a flow diagram is provided that illustrates a method 300 for providing attack path discovery management using an attack path discovery engine in a security management system. At block 302, an attack path discovery computation model is accessed. At block 304, a computing environment graph comprising computing components of a computing environment is accessed. At block 306, using the attack path discovery computation model, identify a plurality of attack paths associated with the computing environment. At block 308, communicate the plurality of attack paths for the computing environment.

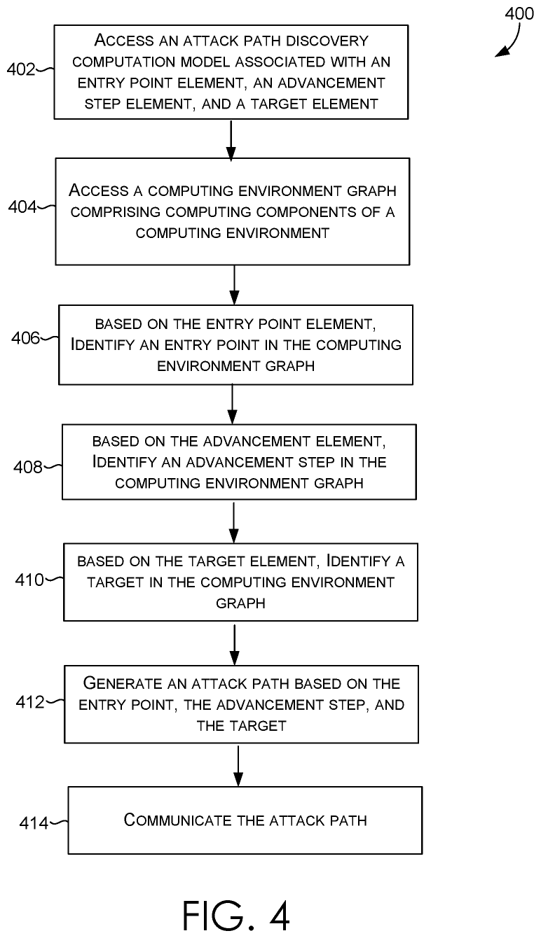

Turning to FIG. 4, a flow diagram is provided that illustrates a method 400 for providing attack path discovery management using an attack path discovery engine in a security management system. At block 402, an attack path discovery computation model associated with an entry point element, an advancement step element, and a target element of an attack path discover template, is accessed. At block 404, a computing environment graph comprising computing components of a computing environment is accessed. At block 406, based on the entry point element, an entry point in the computing environment graph is identified. At block 408, based on the advancement step element, an advancement step in the computing environment graph is identified. At block 410, based on the target element, a target in the computing environment graph is identified. At block 412, an attack path is generated based on the entry point, the advancement step, and the target. At block 414, an attack path is communicated.

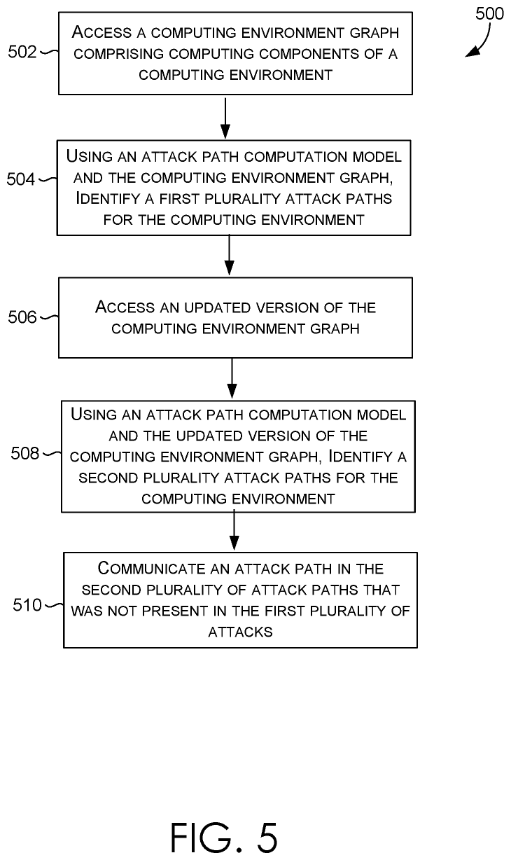

Turning to FIG. 5, a flow diagram is provided that illustrates a method 500 for providing attack path discovery management using an attack path discovery engine in a security management system. At block 502, a computing environment graph comprising computing components of a computing environment is accessed. At block 502, using an attack path computation model and the computing environment graph, a first plurality of attack paths for the computing environment is identified. At block 506, an updated version of the computing environment graph is accessed. At block 508, using the attack path computation model and the updated version of the computing environment graph, a second plurality of attack paths is identified for the computing environment. At block 510, an attack path in the second plurality of the attack paths that is not present in the first plurality of attack paths is communicated.

### Technical Improvement

Embodiments of the present technical solution have been described with reference to several inventive features (e.g., operations, systems, engines, and components) associated with a security management system. Inventive features described include: operations, interfaces, data structures, and arrangements of computing resources associated with providing the functionality described herein relative with reference to an attack path discovery engine. Functionality of the embodiments of the present technical solution have further been described, by way of an implementation and anecdotal examples—to demonstrate that the operations (e.g., using an attack path computation model to traverse a computing environment graph to automatically identify attack paths) for providing the attack path discovery engine. The attack path discovery engine is as a solution to a specific problem (e.g., limitations in effective identification and management of attack paths in computing environment) in security management technology. The attack path discovery engine improves computing operations associated with security investigations and providing security posture information in security management systems.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 6 in particular, an example operating environment for implementing embodiments of the present technical solution is shown and designated generally as computing device 600. Computing device 600 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing an attack path discovery computation model, wherein the attack path discovery computation model supports automatically discovering attack paths for computing environments associated with computing environment graphs;
using the attack path discovery computation model and a computing environment graph for a computing environment, identifying a plurality of attack paths associated with the computing environment; and
communicate the plurality of attack paths for the computing environment.

2. The system of claim 1, wherein the attack path discovery computation model further accesses an attack path discovery template comprising an entry point element, an advancement step element, and a target element associated with corresponding conditions that are evaluated to identify the plurality of attack paths.

3. The system of claim 2, wherein identifying an attack path comprises:
based on the entry point element, identifying an entry point in the computing environment graph;
based on the advancement step element, identifying an advancement step in the computing environment graph;
based on the target element, identifying a target in the computing environment graph; and
generating the attack based on the entry point, the advancement step, and the target.

4. The system of claim 1, wherein:
the entry point element is associated with two or more of the following: an entry point tile, an entry point node, an entry point insight, and an entry point condition;
the advancement step element is associated with three or more of the following a source node, an edge, a target node, a target node condition, an edge condition, and an action; and
the target element is associated with two or more of the following: a target title, a target, a target insight, and a target condition.

5. The system of claim 1, the operations further comprising storing the plurality of attack paths in an attack path database, wherein the attack path database is associated with one or more security services via an attack path data Application Programming Interface (API), wherein the one or more security services access the plurality of attack paths to support executing security operations.

6. The system of claim 1, the operations further comprising communicating a security posture visualization comprising an attack path, wherein the attack path is associated with a prioritization identifier and a risk score.

7. The system of claim 1, the operations further comprising:
accessing an updated version of the computing environment graph;
using the attack path computation model and the updated version of the computing environment graph, identify a second plurality of attack paths for the computing environment;
communicate the second plurality of attack paths for the computing environment.

8. The system of claim 1, the operations further comprising:
receiving a request for the security posture of the computing environment;
generating a security posture visualization associated with the computing environment, wherein the security posture visualization comprises one or more attack paths; and
communicating the security posture visualization comprising the one or more attack paths.

9. The system of claim 1, the operations further comprising:
communicating a request for security posture associated with a computing environment;
based on the request, receiving a security posture visualization associated with the computing environment, wherein the security posture visualization is associated with one or more attack path; and
causing display of the security visualization comprising the one or more attack for the computing environment.

10. The system of claim 1, the operations further comprising:
receiving an indication to execute a remediation action associated with an attack path associated with the security visualization; and
executing the remediation action.

11. One or more computer-storage media having computer-executable instructions embodied thereon that, when executed by a computing system having a processor and memory, cause the processor to perform operations, the operations comprising:
communicating a request for security posture associated with a computing environment;
based on the request, receiving a security posture visualization associated with the computing environment, wherein the security posture visualization is associated with one or more attack path, the one or more attack paths are associated with an attack path discovery computation model supports automatically discovering attack paths for computing environments associated with computing environment graphs; and
causing display of the security visualization comprising the one or more attack for the computing environment.

12. The media of claim 11, wherein the attack path discovery computation model is associated with an entry point element, an advancement step element, and a target elements associated with corresponding conditions that are evaluated to identify the plurality of attack paths.

13. The media of claim 11, wherein the attack path discovery model is operable on a plurality of computing environment based on traversing corresponding computing environment graphs that include nodes and edges representing computing components and features of corresponding computing environments.

14. The media of claim 11, the operations further comprising:
receiving a request for the security posture of the computing environment;
generating a security posture visualization associated with the computing environment, wherein the security posture visualization comprises one or more attack paths; and
communicating the security posture visualization comprising the one or more attack paths.

15. The media of claim 11, the operations further comprising:
receiving an indication to execute a remediation action associated with an attack path associated with the security visualization; and
executing the remediation action.

16. A computer-implemented method, the method comprising:
accessing an attack path discovery computation model, wherein the attack path discovery computation model supports automatically discovering attack paths for computing environments associated with computing environment graphs;
accessing a computing environment graph comprising computing components of a computing environment;
using the attack path discovery computation model and the computing environment graph, identifying a plurality of attack paths associated with the computing environment; and
communicate the plurality of attack paths for the computing environment.

17. The method of claim 16, wherein the attack path discovery computation model further accesses an attack path discovery template comprising an entry point element, an advancement step element, and a target element associated with corresponding conditions that are evaluated to identify the plurality of attack paths.

18. The method of claim 17, wherein identifying an attack path comprises:
based on the entry point element, identifying an entry point in the computing environment graph;
based on the advancement step element, identifying an advancement step in the computing environment graph;
based on the target element, identifying a target in the computing environment graph; and
generating the attack based on the entry point, the advancement step, and the target.

19. The method of claim 16, the method further comprising:
storing the plurality of attack paths in an attack path database, wherein the attack path database is associated with one or more security services via an attack path data Application Programming Interface (API), wherein the one or more security services access the plurality of attack paths to support executing security operations.

20. The method of claim 16, the method further comprising:
accessing an updated version of the computing environment graph;
using the attack path computation model and the updated version of the computing environment graph, identifying a second plurality of attack paths for the computing environment;
communicating the second plurality of attack paths for the computing environment.
